(19) United States
(12) Patent Application Publication
(10) Pub. No.: US 2022/0356021 A1
(43) Pub. Date: Nov. 10, 2022

(54) BLOCKAGE REMOVAL OF HEAT SOURCES ON CONVEYOR RAIL

(71) Applicant: PHILIP MORRIS PRODUCTS S.A., Neuchatel (CH)

(72) Inventors: Gabriele Benni, Sasso Marconi (IT); Fulvio Pastore, Bologna (IT)

(21) Appl. No.: 17/762,913

(22) PCT Filed: Sep. 25, 2020
(86) PCT No.: PCT/EP2020/076892

§ 371 Date: Mar. 23, 2022

(30) Foreign Application Priority Data
Sep. 27, 2019 (EP) 19200184.0

(51) Int. Cl. B65G 43/08; B65G 21/20; B65G 45/00; A24D 1/22

(52) U.S. Cl. CPC B65G 43/08; B65G 21/2072; B65G 45/00; A24D 1/22; B65G 2203/0233; B65G 2203/041; B65G 2203/044; B65G 51/03

(57) ABSTRACT

The invention relates to a conveying system comprising a conveyor rail configured for conveying heat sources for aerosol-generating articles. The system further comprises a heat source detector configured to detect heat sources conveyed by the conveyor rail. The system further comprises a moving actuator. The moving actuator is configured to move the conveyor rail in a direction perpendicular to the conveying direction. The moving actuator is configured to move the conveyor rail if the heat source detector detects absence of heat sources for a predetermined time.

The present invention relates to a conveying system.

It is known to provide heat sources for aerosol-generating articles. A heat source may comprise combustible material such as a powder unit comprising a combustible powder. Further, the heat source may comprise a heat conductive material such as aluminum. The heat source may be arranged in proximity of a sensorial media such as tobacco of the aerosol-generating article in the final aerosol-generating article. The heat conductive material may be arranged between the sensorial media and the combustible material so that heat generated by the combustible material can be transferred to the sensorial media.

During production, the heat sources may be delivered from a feeder to machinery dedicated to combining the heat sources with the further parts of the aerosol-generating article or directly to packaging. The heat sources may be transported during this process in a conveying system. During conveying the heat sources through the conveying system, the heat sources may create a conveying defect such as on undesired blockage. Further, during conveying the heat sources through the conveying system, the heat sources may be damaged.

It would be desirable to have a conveying system which reduces or prevents undesired blockage of the conveyed objects such as heat sources for aerosol-generating articles. It would be desirable to have a conveying system which reduces or prevents undesired damaging of the conveyed objects such as heat sources for aerosol-generating articles.

According to an embodiment of the invention there is provided a conveying system comprising a conveyor rail configured for conveying heat sources for aerosol-generating articles. The system further comprises a heat source detector configured to detect heat sources conveyed by the conveyor rail. The system further comprises a moving actuator. The moving actuator is configured to move the conveyor rail in a direction perpendicular to the conveying direction. The moving actuator is configured to move the conveyor rail if the heat source detector detects absence of heat sources for a predetermined time. The conveyor rail may be configured as a guiding rail.

A conveying defect of heat sources may be removed by movement of the conveyor rail by the movement actuator. In some embodiments, the conveying defect is a blockage of heat sources. Particularly, a conveying defect of heat sources upstream of the heat source detector may be removed due to detection of an absence of heat sources by the heat source detector for a predetermined time. The absence of heat sources may indicate a conveying defect upstream of the heat source detector. The movement of the conveyor rail by the movement actuator may remove this upstream blockage.

In some embodiments, the movement actuator is arranged upstream of the heat source detector. Alternatively, the movement actuator may be arranged in the vicinity of the heat source detector. If the movement actuator is arranged in the vicinity of the heat source detector, the area of the conveyor rail in the vicinity of the heat source detector is preferably moved by the movement actuator, when a conveying defect is detected by the heat source detector. If the movement actuator is arranged upstream of the heat source detector, the area of the conveyor rail upstream of the heat source detector is preferably moved by the movement actuator, when a conveying defect is detected by the heat source detector.

In one embodiment, the conveyor rail is made of a flexible material such that the conveyor rail can be elastically deformed. The conveyor rail may be continuous. The movement of the conveyor rail by the moving actuator may be realized by moving an area of the continuous conveyor rail. The conveyor rail may be deformed by the moving actuator so as to move this area of the conveyor rail. The area of the conveyor rail moved by the moving actuator may be flexible. The deformation of the conveyor rail may be a lateral deformation. The deformation of the conveyor rail may be in a direction perpendicular to the conveying direction.

The terms ‘upstream’ and ‘downstream’ refer to positions defined by the conveying direction of the heat sources within the conveying system. The term ‘downstream’ refers to a direction along the conveying direction. The term ‘upstream’ refers to a direction opposite the conveying direction.

As used herein, the term ‘vibrating conveyor rail’ refers to a vibrating conveying system. A vibrating conveying system conveys objects in the conveying direction by means of a vibrating conveyor base.

As used herein, the term ‘non-vibrating conveyor rail’ refers to a non-vibrating conveying system. A non-vibrating conveyor system does not convey objects in the conveying direction by means of a vibrating conveyor base. In other words, a non-vibrating conveying system conveys objects in the conveying direction by means of a conveyor base which is configured as a non-vibrating conveyor base.

Advantageously, the conveyor rail is configured as a non-vibrating conveyor rail. In other words, the conveyor rail is advantageously not configured as a vibrating conveyor rail. In other words, the conveying system is advantageously not configured as a vibrating conveying system. Specifically for the purpose of conveying heat sources, a vibrating conveyor rail may be disadvantageous. In a conventional vibrating conveyor rail, the conveyor rail is vibrated to convey the objects on the conveyor rail. The vibration of a vibrating conveyor rail may damage the heat sources. Particularly, the heat sources as described in more detail below may comprise a compressed carbon powder that may be damaged by vibrations of the heat sources particularly by collisions between the heat sources and the conveyor rail and by collisions between individual heat sources. As a consequence, the conveyor rail according to the present invention is preferably configured as a non-vibrating conveyor rail. In other words, the conveying system according to the present invention is preferably configured as a non-vibrating conveying system. If the moving actuator is utilizing vibration as described in the following, this vibration is preferably a temporary vibration for removing a conveying defect.

The moving actuator may be configured as a vibration actuator. The moving actuator may be configured to vibrate the conveyor rail. The moving actuator is preferably configured to vibrate the conveyor rail temporarily. The vibration of the conveyor rail may remove a conveying defect of the heat sources. Particularly in a blockage of heat sources, the heat sources may be pressed against the conveyor rail so that the vibration of the conveyor rail is transferred to the heat sources. The vibration of the heat sources may remove the blockage. The vibrations of the vibration actuator may be generated by any known means, preferably by rotation of eccentric weights. The vibration actuator may comprise a motor, preferably an electric motor, for creating the vibrations. The motor may be a linear motor throughout the specification. The vibration actuator may utilize a predetermined waveform for creating the movement of the vibration actuator. One or both of the frequency and amplitude of the movement of the vibration actuator may be controlled. One or both of the frequency and amplitude may be controlled by the controller based upon the output of the heat source detector.

The moving actuator may be configured as a vibration actuator and the conveying system may be configured as a non-vibrating conveying system.

The moving actuator may be configured as a shock actuator. A ‘shock’ refers to a short engagement of the moving actuator. Advantageously, the shock of the shock actuator takes a short time. The duration of the shock may be below 1 second, preferably below 0.5 seconds, more preferably below 0.1 seconds. The duration of the shock refers to the time of movement of the moving actuator.

The movement of the shock actuator is preferably a fast movement, preferably a snapping movement. This movement is configured to transfer an impulse spike to the conveyor rail. This movement is preferably a translational movement. The movement may comprise, preferably consist of, a single movement. The single movement may comprise one wavelength of an envelope of a predetermined waveform. One or both of the frequency and amplitude of the movement of the shock actuator may be controlled. One or both of the frequency and amplitude may be controlled by the controller based upon the output of the heat source detector. Alternatively, the movement may comprise a few successive movements, preferably less than 10 successive movements, preferably less than 5 successive movements, more preferably less than 3 successive movements. The moving actuator may comprise a linear motor or rotating eccentric weights to create the shock. According to this embodiment, the moving actuator may be directly coupled to the conveyor rail so that the movement of the moving actuator directly moves the conveyor rail. Alternatively, the moving actuator may be arranged distanced from the conveyor rail and the moving actuator may be configured to create the shock by hitting the conveyor rail.

The moving actuator may be coupled to the conveyor rail. In one embodiment, the moving actuator is provided as a pneumatic, a hydraulic, an electric or as a mechanical moving actuator or a combination thereof. In one embodiment, the moving actuator is firmly attached to the conveyor rail. In other embodiments, the moving actuator is configured to be coupleable and detachable to or from the conveyor rail. The moving actuator may be configured movable. The movement actuator may be configured movable along the length of the conveyor rail. The movement actuator may be configured to move between different areas of the conveyor rail. The movement actuator may be configured coupleable and detachable to or from different areas of the conveyor rail. The movement actuator may be configured to move these different areas of the conveyor rail for removing corresponding conveying defects. The moving actuator may be configured movable in an upstream and a downstream direction parallel to the conveyor rail. Additionally, the moving actuator may be configured to move the conveyor rail in the different areas laterally for removing the conveying defects after coupling to the respective areas. Alternatively or additionally, the moving actuator may be configured movable in a vertical, circular or elliptic direction with respect to the conveyor rail or any combination thereof.

Alternatively, multiple moving actuators may be provided. In this case, multiple areas of the conveyor rail may be movable by individual moving actuators. Each movable area of the conveyor rail may be coupleable with a moving actuator so that each of these areas may be independently moved by the respective moving actuator. In one embodiment, a number of moving actuators is provided smaller than the number of movable areas of the conveyor rail. In this case, the moving actuators may be provided movable between different areas of the conveyor rail so that multiple areas of the conveyor rail can be moved simultaneously by respective multiple moving actuators.

The conveying system may further comprise mounting elements. The conveyor rail may be mounted on the mounting elements. The mounting elements may be configured to enable movement of the conveyor rail perpendicular to the conveying direction. The mounting elements may be arranged below the conveyor rail. Preferably, a multitude of mounting elements is provided.

The mounting elements may be configured flexible. The flexibility of the mounting elements may be chosen such that the movement of the conveyor rail by means of the moving actuator is limited by the mounting elements. The moving actuator may transfer a force to the conveyor rail and the resulting movement of the conveyor rail may be controlled by choosing an appropriate flexibility of the mounting elements.

The flexible mounting elements may be elastic mounting elements. The elastic mounting elements may comprise an elastic material. An elastic material may be a plastic material, for example an elastomeric material. The elastic mounting elements may comprise a spring, for example a metal spring or an air spring. The elastic mounting elements may comprise a shock absorber. The flexibility of the elastic mounting elements may be adjusted by varying the elasticity of the elastic mounting elements. The elasticity of the elastic mounting elements may be chosen such that the movement of the conveyor rail by means of the moving actuator is limited by the mounting elements. The movement of the moving actuator may be damped by the flexible mounting elements.

The mounting elements may be configured movable, preferably slidably movable, in a direction perpendicular to the conveying direction. In other words, the mounting elements may be configured laterally movable. The lateral movement of the mounting elements may enable lateral movement of the conveyor rail. The lateral movement of the conveyor rail may result in removal of a conveying defect of the heat sources. Particularly if the moving actuator is configured as a vibration actuator, the laterally movable mounting elements may enable vibration of the conveyor rail.

The conveying system may further comprise a conveyor base. The heat sources may be conveyed on the conveyor base. The conveyor base may be configured as a supporting surface. The conveyor base may be flat. The conveyor base may preferably be configured as a non-vibrating conveyor base. The heat sources may be conveyed on the conveyor base by air jets created by air jet generators. The conveyor base may comprise a downward slope in a conveying direction such that the heat sources may be conveyed on the conveyor base by gravity. The conveyor base may comprise rolls for conveying the heat sources. The conveyor base may comprise an endless belt conveyor for conveying the heat sources.

The conveyor rail may be configured as a guiding rail limiting lateral movement of the heat sources. The conveyor rail may be arranged adjacent the conveyor base. The conveyor rail may be configured as a sidewall adjacent the conveyor base. The conveyor base may be configured as a bottom part.

The conveying system may comprise a second conveyor rail. The second conveyor rail may preferably be configured as a second guiding rail limiting lateral movement of the heat sources. The second guiding rail may preferably be arranged opposite the first conveyor rail. The first and second guiding rail may limit lateral movement of the heat sources.

The moving actuator may be arranged laterally next to the conveyor rail. The moving actuator may be arranged in the conveying plane of the conveyor rail. The conveying plane may be defined by the surface on which the heat sources are conveyed. This surface may be facilitated by the conveyor rail or the conveyor base. Arranging the moving actuator laterally may result in the moving actuator transferring a force to the conveyor rail such that the conveyor rail is moved laterally by the moving actuator. The moving actuator may be arranged to laterally vibrate the conveyor rail. Alternatively or additionally, the moving actuator may be arranged below the conveyor rail. The moving actuator may be arranged below the conveying plane of the conveyor rail. Such an arrangement of the moving actuator may result in a vertical movement of the conveyor rail thereby transferring a force to the conveyor rail. The moving actuator may be arranged to vertically vibrate the conveyor rail.

The heat source detector may be configured as a proximity sensor. The heat source detector may comprise an optical emitter and an optical sensor. The heat source detector may comprise an IR emitter and an IR sensor. The heat source detector may comprise an IR LED and an IR sensor. The heat source detector may comprise a camera.

In one embodiment, the heat source detector is provided as a proximity heat source detector such as a proximity laser heat source detector. The heat source detector may be arranged directly above the conveyor rail or conveyor base so as to measure the distance between the conveyor rail or conveyor base and the heat source detector. If a heat source passes below the proximity heat source detector on the conveyor rail or conveyor base, the heat source detector detects that a heat source is arranged below the proximity heat source detector. Also, different orientations of the heat source may be detected by the heat source detector, if these different orientations result in a different distance between the heat source and the heat source detector. The proximity heat source detector may also be arranged adjacent to the conveyor rail or conveyor base for measuring the presence of a heat source on the conveyor rail or conveyor base. An optical heat source detector such as a camera may also be employed. The heat source detector may be configured as an optical barrier. Other heat source detectors for detecting a conveying defect may also be used. For example, a heat source detector with electrical contacts may be provided for measuring an electric property of the heat sources passing next to the heat source detector. For example, if different areas of the heat sources have different electrical properties such as different electrical resistances, such a heat source detector may detect the presence and the orientation of a passing heat source based upon the measured electrical property.

In one embodiment, the heat source detector detects a conveying defect, if a heat source in a specific orientation is detected by the heat source detector. Additionally or alternatively, the heat source detector may detect a conveying defect, if at least one heat source detected by the heat source detector is no longer moving along the surface of the conveyor rail or conveyor base. In some embodiments, the heat source detector may detect a conveying defect, if the time between the passage of subsequent heat sources passing over the conveyor rail or conveyor base exceeds a pre-determined threshold. For example, an average distance between two heat sources may be used together with a known conveying speed to calculate the average time between two heat sources in the conveying direction. The time after which a conveying defect is detected may be at least two times the average time between two heat sources. Also, the statistical temporal distribution of the heat sources may be determined and a conveying defect may be detected after a significant time passes between two heat sources. The significant time could be calculated based upon the statistical temporal distribution of the heat sources. The statistical temporal distribution could be pre-determined or measured by a heat source detector, preferably by the heat source detector for detecting a conveying defect. The statistical temporal distribution might be measured during a calibration run of the conveying system.

The conveyor rail or conveyor base may comprise a downward slope in a conveying direction. The conveyor rail may be provided with a low friction coating. One or both of these configurations may aid conveying the heat sources.

The conveying system may comprise air jet generators configured to create air jets for conveying the heat sources. The air jet generators may be arranged adjacent the conveyor rail. The air jet generators may be arranged in the conveying plane of the conveyor rail. The air jet generators may be arranged laterally adjacent the conveyor rail. The air jet generators may comprise air jet applicators for directing the air jets generated by the air jet generators. In this embodiment, the air jet generators may be arranged distanced from the conveyor rail and the above mentioned placements of the air jet generators may instead apply to the air jet applicators. The air jet generators may be configured to create air jets. The air jets may be directed towards a contacting surface of the conveyor rail or conveyor base which contacts the heat sources. As a consequence, the air jets may be provided between the conveyor rail or conveyor base and the heat sources to be conveyed. The heat sources may then be conveyed on a cushion of air, reducing friction.

The conveying system may comprise at least two heat source detectors and at least two moving actuators. The conveying system may comprise a controller configured to control actuation of the movement actuators. The controller may be configured to receive an output of the heat source detectors. The controller may be configured to control operation of the moving actuators based on the output of the heat source detectors.

Operation of the moving actuators may comprise actuation of at least two moving actuators at the same time. Operation of the moving actuators may comprise actuation of at least two moving actuators subsequently. The actuation of the moving actuators may be controlled by the controller depending upon the output of the heat source detectors. The controller may be configured to detect a type of conveying defect depending upon the output of the heat source detectors. Exemplarily, if at least two heat source detectors detect a conveying defect at the same time, the controller may determine that actuation of at least two moving actuators is warranted to remove the conveying defect. The controller may be configured to control actuation of moving actuators in the vicinity of the heat source detectors that have created an output indicating a conveying defect. To securely remove the conveying defect, the controller may be configured to control activation of a moving actuator, preferably at least two moving actuators, upstream of the heat source detector that has detected a conveying defect. Activating moving actuators upstream of the detected conveying defect may securely remove the conveying defect due to clearing potentially undetected conveying defects upstream of the heat source detector.

The invention further relates to a system comprising a conveying system as described herein and at least one heat source for an aerosol-generating article as described herein.

The heat source may comprise combustible material, preferably carbonaceous material, and heat conductive material, preferably aluminum.

The heat source may have a cylindrical shape. Preferably, the conveying system may be configured to convey the heat source in a horizontal rolling orientation. Alternatively, the conveying system may be configured to convey the heat sources in a standing vertical orientation.

Preferably, the heat sources may have a polygonal cross section, for example with three or more sides. In one embodiment, the cross section of the heat sources is oval or semicircular. In some embodiments, the heat sources have a cylindrical shape. In some embodiments, the heat sources have the shape of a right circular cylinder. In some embodiments, the heat sources have the shape of an elliptic cylinder, a parabolic cylinder, or a hyperbolic cylinder. In one preferred embodiment, the heat sources are provided as cylindrical objects. In some embodiments, the top faces of the heat sources are parallel to the bottom faces of the heat sources. In some embodiments, the side faces of the heat sources are parallel to each other. Preferably, the heat sources are identical.

In one embodiment, the heat sources may be prismatic objects. The heat sources may be configured as cylindrical heat sources which are used in the manufacturing of aerosol-generating articles. Such heat sources comprise a powder unit containing combustible powder, which is compressed and delivered in a cylindrical shape. A carbon based powder may be utilized in the powder unit. Also, the heat source comprises a heat conductive material, for example metal such as aluminium. The heat conductive material is in contact with the powder unit. The heat conductive material is arranged at a top of the heat source, while the powder unit is arranged at a bottom of the heat source. The top as well as the bottom of the heat source are arranged perpendicular to the longitudinal axis of the heat source. The heat source has a cylindrical shape, wherein the length of the heat source is larger than the diameter of the heat source. The length of the heat source is measured along the longitudinal cylindrical axis of the heat source. The diameter of a prismatic object such as a heat source is between around 0.1 to 1.5 millimeter, preferably 0.3 to 1.0 millimeter, and more preferably 0.5 to 0.7 millimeter. The length or height of the prismatic object such as a heat source is around 0.5 to 2.0 millimeter, preferably 0.7 to 1.5 millimeter, and more preferably 0.9 to 1.1 millimeter.

In one embodiment, the heat sources should be conveyed in an upright position standing on the conveyor base. In this embodiment, the correct orientation is an orientation, in which the longitudinal axis of the heat sources should be perpendicular to the plane of the conveyor base. Furthermore, the heat conductive material is arranged on top of the heat sources, while the powder unit is arranged at the bottom of the heat sources in contact with the conveyor base.

The invention may further relate to a method for removing a blockage within a conveying system as described herein. The method may comprise detecting, by means of the heat source detector, of an absence of heat sources for a predetermined time. The method may comprise moving, by means of the moving actuator, of the conveyor rail in a direction perpendicular to the conveying direction. The method may comprise controlling, by means of the controller, of the moving actuator based on the output of the heat source detector.

Features described in relation to one embodiment may equally be applied to other embodiments of the invention.

The invention will be further described, by way of example only, with reference to the accompanying drawings in which:

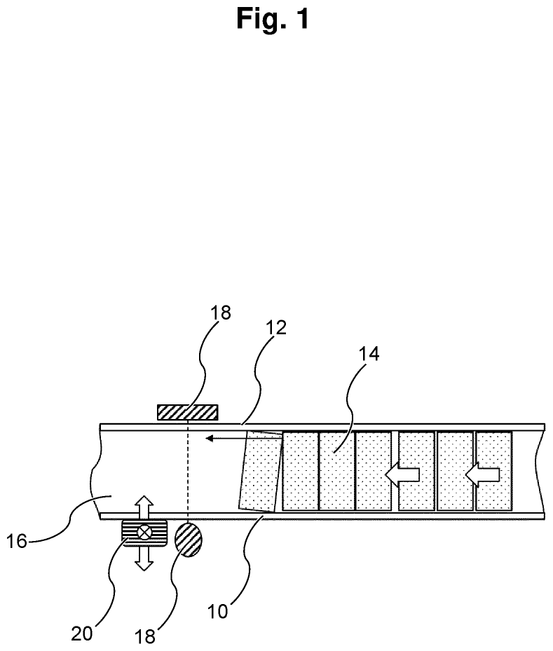

FIG. 1 shows an illustrative conveying system according to the present invention; and

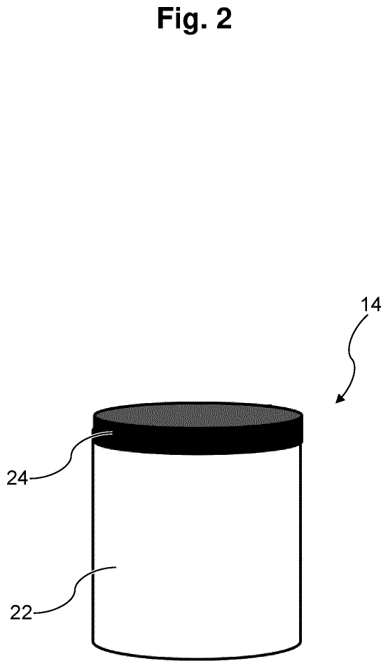

FIG. 2 shows a heat source to be conveyed on the conveying system.

FIG. 1 shows a conveying system. The conveying system comprises a first conveyor rail 10. Opposite of the conveyor rail, a second conveyor rail 12 is arranged. The first conveyor rail 10 and the second conveyor rail 12 are configured as guiding rails for laterally guiding conveying of heat sources 14. The heat sources 14 to be conveyed in the conveying system are described in more detail below with reference to FIG. 2.

The heat sources 14 are conveyed on a conveyor base 16. For simplicity, one or more of the first conveyor rail 10, the second conveyor rail 12 and the conveyor base 16 is referred to within this disclosure as conveyor rail. The conveyor base 16 is configured as a supporting surface. As shown in FIG. 1, the heat sources 14 are arranged on the conveyor base 16 in a lying rolling arrangement. In the lying rolling arrangement, the longitudinal axis of the heat sources 14 is parallel to the plane of the conveyor base 16. In other words, the cylindrical side surface of the heat sources 14 contacts the conveyor base 16 in this arrangement. The conveying direction of the heat sources 14 is indicated by the arrows in FIG. 1.

The conveying system comprises a heat source detector 18. The heat source detector 18 is configured as a proximity sensor. The heat source detector 18 is configured to detect when a heat source 14 passes the heat source detector 18. The heat source detector 18 is further configured to measure the time between detection of individual heat sources 14. The heat source detector 18 is further configured to output a signal, when the time between detection of individual heat sources 14 exceeds a predetermined threshold.

The conveying system further comprises a controller (not shown) for receiving the output of the heat source detector 18. The controller is configured to control operation of a moving actuator 20. The controller is configured to control operation of the moving actuator 20 on basis of the output of the heat source detector 18. Particularly, if the controller receives an output of the heat source detector 18 that the time between detection of individual heat sources 14 has exceeded the predetermined threshold, the controller concludes that a conveying defect, particularly a blockage, of heat sources 14 has occurred. The conveying defect is detected to have occurred upstream of the heat source detector 18. In FIG. 1, a blockage of heat sources 14 is depicted, since the most downstream heat source 14 has a twisted orientation and is jammed between the first conveyor rail 10 and the second conveyor rail 12. Subsequent upstream heat sources 14 are pushed into the jammed heat source 14 so that the conveying defect occurs.

As a consequence of the detection of the conveying defect, the controller is configured to control actuation of the moving actuator 20. The moving actuator 20 is configured to move the conveyor rail. In the embodiment shown in FIG. 1, the moving actuator 20 is configured to move the first conveyor rail 10. However, the moving actuator 20 may be configured to move one or more of the first conveyor rail 10, the second conveyor rail 12 and the conveyor base 16. Preferably, the first conveyor rail 10, the second conveyor rail 12 and the conveyor base 16 are connected with each other or integral such that movement of the first conveyor rail 10 also moves the second conveyor rail 12 and the conveyor base 16. The moving actuator 20 is configured as a vibration or shock actuator. Consequently, the moving actuator 20 is configured to vibrate or shock the first conveyor rail 10, the second conveyor rail 12 and the conveyor base 16. The moving actuator 20 is arranged laterally next to the first conveyor rail 10. The moving actuator 20 is configured to laterally move the first conveyor rail 10.

In the embodiment shown in FIG. 1, the moving actuator 20 is arranged in the vicinity of the heat source detector 18. Thus, activation of the moving actuator 20 vibrates the area in the vicinity of the heat source detector 18. This vibration may be sufficient to remove the conveying defect. Particularly, the vibration of the conveyor rail may vibrate the heat sources 14 to remove the conveying defect. Alternatively, the moving actuator 20 may be arranged upstream of the heat source detector 18. Since detection of a conveying defect by means of the output of the heat source detector 18 means detection of a conveying defect upstream of the heat source detector 18, the moving actuator 20 may be arranged upstream of the heat source detector 18 to remove the conveying defect in this upstream location.

Alternatively or additionally, at least two heat source detectors 18 may be provided. Alternatively or additionally, at least two moving actuators 20 may be provided. The number of heat source detectors 18 and moving actuators 20 may be adapted to the specific system. Exemplarily, a single heat source detector 18 may be provided and at least two moving actuators 20 may be provided. The at least two moving actuators 20 may be provided in the vicinity of the heat source detector 18 or upstream of the heat source detector 18. Also, one moving actuator 20 may be provided in the vicinity of the heat source detector 18 and one or more moving actuators 20 may be provided upstream of the heat source detector 18. The controller may be configured to control activation of the at least two moving actuators 20. Exemplarily, detection of a conveying defect by a heat source detector 18 may lead to the controller activating at least two moving actuators 20, exemplarily in the vicinity of the heat source detector 18 and upstream of the heat source detector 18 or only upstream of the heat source detector 18.

FIG. 2 shows an embodiment of a heat source 14 to be conveyed by the conveying system. The heat source 14 comprises a powder unit 22 containing combustible powder, which is compressed and delivered in a cylindrical shape. The combustible powder is a carbon based powder. Further, the heat source 14 comprises a heat conductive material 24, for example metal such as aluminium. The heat conductive material 24 is in contact with the powder unit 22. The heat conductive material 24 is arranged at a top of the heat source, while the powder unit 22 is arranged at a bottom of the heat source. As shown in FIG. 2, the heat source 14 has a cylindrical shape. During conveying the heat source 14 in the conveying system, the heat source 14 preferably is arranged in a lying orientation such that the individual heat sources 14 can roll on the conveyor base 16.

1-16. (canceled)

17. Conveying system comprising:
a conveyor rail configured for conveying heat sources for aerosol-generating articles;
a heat source detector configured to detect heat sources conveyed by the conveyor rail; and
a moving actuator, wherein the moving actuator is configured to move the conveyor rail in a direction perpendicular to the conveying direction, wherein additionally the moving actuator is arranged below the conveying plane of the conveyor rail and is arranged to vertically vibrate the conveyor rail, wherein the moving actuator is configured to move the conveyor rail if the heat source detector detects absence of heat sources for a predetermined time, wherein the conveyor rail is configured as a guiding rail, and wherein the moving actuator is configured as a vibration actuator.

18. Conveying system according to claim 17, wherein the conveying system is not configured as a vibrating conveying system.

19. Conveying system according to claim 17, wherein the conveying system further comprises mounting elements, wherein the conveyor rail is mounted on the mounting elements, and wherein the mounting elements are configured to enable movement of the conveyor rail perpendicular to the conveying direction.

20. Conveying system according to claim 19, wherein the mounting elements are configured flexible.

21. Conveying system according to claim 19, wherein the mounting elements are configured movable, preferably slidably movable, in a direction perpendicular to the conveying direction.

22. Conveying system according to claim 17, wherein the conveying system further comprises a conveyor base, wherein the heat sources are conveyed on the conveyor base, wherein the conveyor rail is configured as a guiding rail limiting lateral movement of the heat sources, and wherein the conveyor base is preferably not configured as a vibrating conveyor base.

23. Conveying system according to claim 22, wherein the conveying system further comprises a second conveyor rail, wherein the second conveyor rail is preferably configured as a second guiding rail limiting lateral movement of the heat sources, and wherein the second guiding rail is preferably arranged opposite the first conveyor rail.

24. Conveying system according to claim 17, wherein one or more of:
the heat source detector is configured as a proximity sensor;
the heat source detector comprises an optical emitter and an optical sensor;
the heat source detector comprises an IR emitter and an IR sensor;
the heat source detector comprises an IR LED and an IR sensor; and
the heat source detector comprises a camera.

25. Conveying system according to claim 17, wherein one or more of:
the conveyor rail comprises a downward slope in a conveying direction; and
the conveyor rail is provided with a low friction coating.

26. Conveying system according to claim 17, wherein the conveying system further comprises air jet generators configured to create air jets for conveying the heat sources.

27. Conveying system according to claim 17, wherein the conveying system comprises at least two heat source detectors and at least two moving actuators, wherein the conveying system comprises a controller configured to control actuation of the movement actuators, wherein the controller is configured to receive an output of the heat source detectors, and wherein the controller is configured to control operation of the moving actuators based on the output of the heat source detectors.

28. System comprising a conveying system according to claim 17 and at least one heat source for an aerosol-generating article.

29. System according to claim 28, wherein the heat source comprises combustible material, preferably carbonaceous material, and heat conductive material, preferably aluminum.

30. System according to claim 28, wherein the heat source has a cylindrical shape, and wherein the conveying system is configured to convey the heat source in a horizontal rolling orientation.
